(19) United States
(12) Patent Application Publication
(10) Pub. No.: US 2010/0119999 A1
(43) Pub. Date: May 13, 2010

(54) Visual/Tactile teaching aid and system

(76) Inventor: Elizabeth A. Hollywood-Tuck, Barrie (CA)

Correspondence Address: D.W. EGGINS, 18 DOWNSVIEW DRIVE, BARRIE, ON, L4M 4P8, CA

(21) Appl. No.: 12/292,055

(22) Filed: Nov. 12, 2008

(51) Int. Cl. G09B 19/00

(52) U.S. Cl. 434/96; 434/81

(57) ABSTRACT

A teaching system for the perception enhancement of a user provides pairs of objects for visual and tactile comparison wherein the selection of paired objects provide a significant starting point for the construction of extended teaching aides, tactile forms and systems. The present invention may be combined with a range of text associated with paired forms, and includes a range of contrasting terms and synonyms generally associated with the contrasting and complementary nature of the paired forms.

### BACKGROUND OF THE INVENTION

1. This invention is directed to a class of teaching aids and to a system for their utilization.

2. The teaching of accuracy in a person's perception is of great importance. Where a topic or an object is incorrectly perceived men a generalized misapprehension wilt colour all subsequent references to that subject or object, and as well, to associated subjects and objects. It will be understood by those skilled in the art that references to left and right, and symmetry and asymmetry play an important yet unclear role in shaping human perception. Attempts to understand this role are well documented. It will be understood mat models and artistic obscurities of the prior art are linked, wherein a relationship exists whereby clarity requires extended forms.

### BRIEF SUMMARY OF THE INVENTION

The present invention is directed to a teaching system based upon visual and tactile comparison aids having a significant scope and range of possible embodiments, selected from two and three-dimensional illustrations upon pages of a book, or portable tactile forms selected from, but not limited to the group comprising: models, foldout-pamphlets, game cards, adhesive sheets, posters, puzzleboards, blackboards, whiteboards, display boards, gameboards, virtual-electronic medium, or other medium, for use on an individual basis, or in group activities.

The present invention provides a series of illustrations or three-dimensional objects in accordance with the illustrations that can be used for purposes in teaching an improved viewing perspective.

In teaching perception enhancement and detecting certain learning-impairment it is imperative that meaningful contact is established on an individual basis. Such individual contact is frequently extremely difficult to achieve.

The pictorial and associated tangible forms of the physical objects of the present invention readily lend themselves to a range of activities, including games, on both an individual and a group basis that helps break-down barriers of individual reserve, and facilitates establishing a valid, personal, one-on-one contact.

Thus, the adoption of a family of two-dimensional forms (drawings) and three-dimensional models, such as planar cardboard cut-outs of those forms can effectively serve both as introductory contacting agents for establishing effective communication with a ‘student’, and as teaching aids for multi-level instruction.

The subject forms generally rely upon historical representations, with which the persons being taught are quite familiar, so that the initial shock of non-familiarity is avoided, and the forms provide a readily assimilated point of introduction to the topic.

After use of the subject pictures or objects to establish communication with the person or persons being taught, the aids can then be used as a teaching tool to enhance the perceptive powers of the one being taught.

One aspect of perception-teaching is learning to distinguish between symmetry and non-symmetry: i.e. distinguishing between symmetry and asymmetry.

Leading on from that matter of making simple symmetry/asymmetry distinctions can then develop into the capability of perceiving the scope of more extended designs.

Furthermore, the achievement of distinguishing symmetry from asymmetry can then lead into language associations, by the use of associated metaphors and synonyms.

Thus ‘symmetry’ can be associated with congruency, completeness, harmony, proportionality, wholeness, equipoise, and even perfection and lightness.

Correspondingly, ‘asymmetry’ can be associated with the absence of symmetry, incompleteness, being off-set/off-centre/out of balance.

The present invention shows a selection of representations of symmetry and asymmetry, and it will be understood that the scope of illustrative subject matter for this topic is virtually unlimited.

There is a wide range of form for such representation: they may be purely illustrative, as in illustrations upon pages of a book; they may be in the form of cards, as in a card game or puzzle; or as bill-boards or flags; or in the form of lapel badges mat may be worn by participants. In addition to being in the form of printed illustration, they may be three-dimensional representations such as cardboard cut-outs, or even models.

This subject matter may be presented and applied in a variety of ways; for example:
a) in a straightforward teaching mode, using a textbook illustrated in accordance with the present invention;
b) as a puzzle, using illustrations, pamphlets, cards or cut-outs, or 3-D models;
c) as a classroom game, with each participant wearing a badge or a billboard identifying them, for instance, as a symmetrical or as an asymmetrical version of a particular object, so that the two representations of the same object can identify each other and link-up to provide an accurate viewing perspective of the three-dimensional model.

The “Game” approach presents itself as the initial, important step in establishing ‘contact’ with a new pupil or group of participants.

One embodiment of the present invention may comprise three-dimensional ‘regular’ figures, including planar figures of cardboard having two identical forms, such as a pair of rectangular door frames in side by side, mutually spaced relation, having a live hinge in joining relation, such that one can be folded over the other, to physically and visually prove the identicalness of their forms, and hence, their symmetry. The factor of tactile association assumes particular significance in certain stages of psychological development, wherein use of language, interpretation of symbols, and recognition of relationships are integral.

Similarly, two similar but non-identical forms can also have a live hinge in joining relation, to facilitate their mutual comparison, both visually and tactilely, with evident asymmetry being very readily detected.

In a further embodiment, these symmetrical and asymmetrical pairings may be matched up to selected pages of a book having page cut-outs that precisely match the paired forms, and where there is no possibility of the symmetrical forms being accommodated in the asymmetrical cut-outs, or vice versa. These respective ‘symmetrical’ and ‘asymmetrical’ pages may include texts detailing their respective associated metaphors and synonyms, referred to above.

Other contemplated, more advanced figure arrangements include irregular figures, i.e. non-parallelopids, arranged in like aspect, or as mirror images. The latter (mirror images) can be live-hinged (see above), for proof of symmetry.

An earlier form of representation by the present inventor relates to theoretical work in the field of learning-hindered perception, founded on the published work NLR&RC Database© TM2008 in the One-of-a-Kind Field Library, a Division of Natural Law Research and Resource Center wherein timelines present new applications of historical materials for purposes of treating learning-impairment and facilitating perception enhancement in education.

This form of representation adopts the left (L) lobe and right (R) lobe of the brain as meaningful aspects of symmetry and asymmetry, with possible associated implications for both the instructor and the subject (pupil).

It will also be understood that the illustrations and embodiments of the present invention are not subject to quantification by experimentation, and will be unlimited in their presentation of operational information, thus introducing a new preciseness in comparison systems and studies.

### BRIEF DESCRIPTION OF THE SEVERAL VIEWS OF THE DRAWING

Certain embodiments of the invention are illustrated, by way of example, without limitation of the invention thereto, other than as set forth in the accompanying claims; it being understood that further embodiments may be derived by one skilled in the art Reference is made to the accompanying drawings, wherein:

FIG. 1 is a representation of a page illustrating a symmetrical arrangement of rectangular items;

FIG. 2 is a representation of a page illustrating an asymmetrical arrangement of rectangular items;

FIG. 3 is a perspective view of a book embodiment of the present invention;

FIG. 4 is a perspective view of a first illustrated insert for the book of FIG. 3;

FIG. 5 is a perspective view of a second illustrated insert for the book of FIG. 3;

FIG. 6 is a representation of two lobes of a brain;

FIG. 7 is an enlarged view of FIG. 6, having an asymmetric inclusion;

FIG. 8 shows the transition of FIG. 7 to a geometric representation;

FIG. 9A is an ovoid geometric representation;

FIG. 9B is an ovoid geometric representation with an asymmetric inclusion;

FIG. 10A is a rectangular representation, and

FIG. 10B is a rectangular representation with an asymmetric inclusion.

FIG. 11 is a view similar to FIG. 3 of further pages of the subject book; and,

FIGS. 12 and 13 are perspective views of inserts for the FIG. 11 book page.

### DETAILED DESCRIPTION OF THE INVENTION

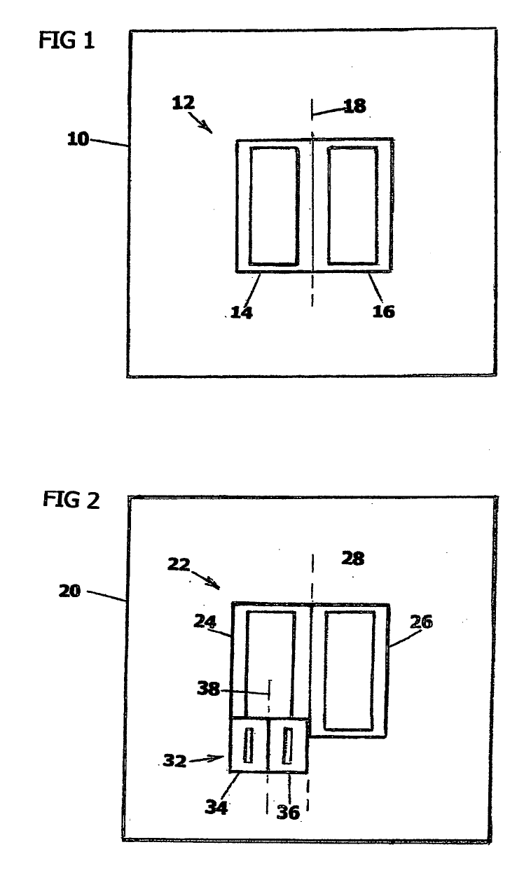

Referring to FIG. 1, a page 10 shows a composite FIG. 12 having identical halves 14 and 16, with an axis of symmetry 18.

Turning to FIG. 2, a page 20 shows a composite FIG. 22 having identical halves 24 and 26, with an axis of symmetry 28, with a superimposed, scaled down FIG. 32 having identical halves 34 and 36, with an axis of symmetry 38, that is off-set from the dominant axis of symmetry 28.

In FIG. 3 a book 40 has thick pages 42, into which are recessed shapes 44, 46, 48 and 50.

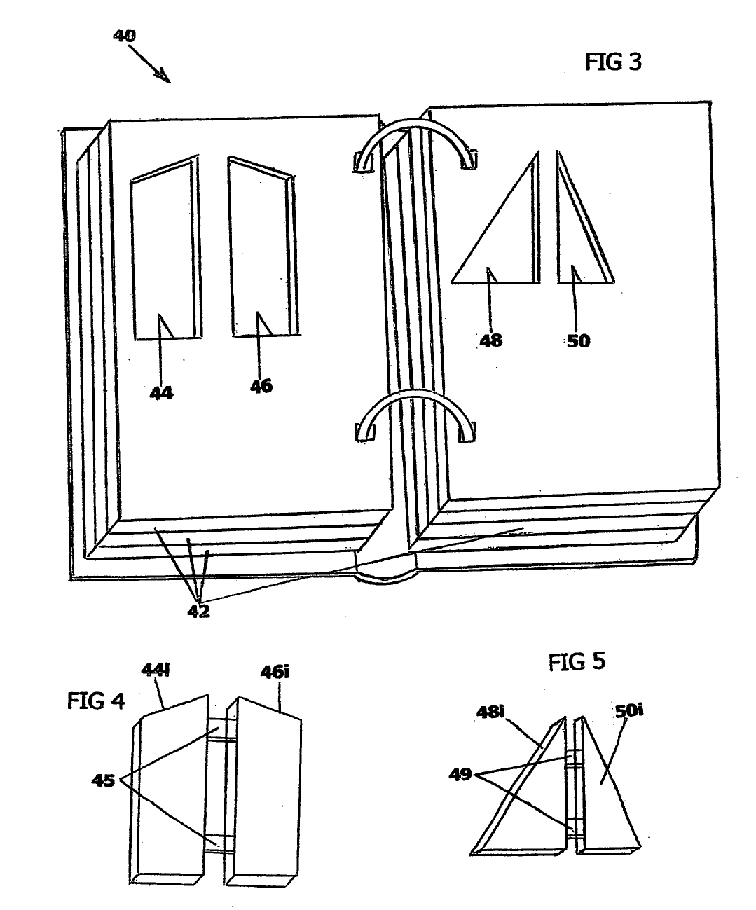

FIG. 4 shows inserts 44i, 46i, 48i and 50i, which are sized to fit precisely into the respective recessed shapes 44, 46, 48 and 50.

Pairs of live hinges 45 and 49 connect the respective inserts 44i-46i and 48i-50i, enabling them to be doubled over into mutually superimposed relation, such that their respective symmetry and asymmetry are tactilely very apparent and readily perceived.

Turning to FIG. 5, this shows a further three-dimensional insert 52 to fit into another page 42 (not shown) of the book 40 of FIG. 3.

Turning to FIG. 6, two diagrammatic substantially symmetrical lobes 54, 56 of a human brain are shown.

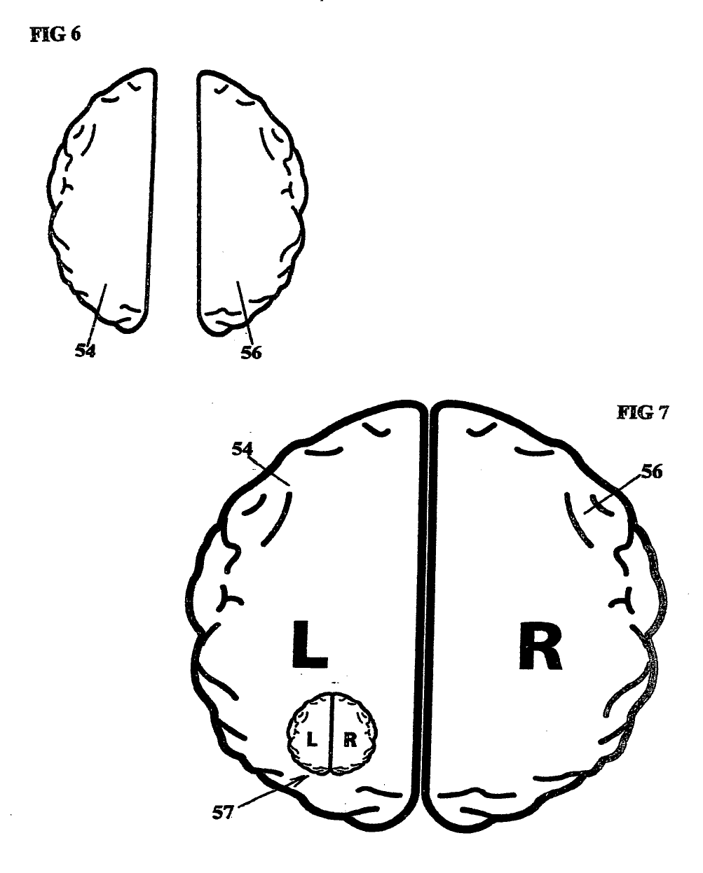

In FIG. 7, the enlarged lobes 54, 56 are labeled L (Left) and R (Right), and are rendered asymmetrical 57, by the superimposition on lobe L of a substantially enlarged L & R image 54, 56.

Turning to FIG. 8, lobes 54, 56 are shown being transitioned to geometrical form 60, with the reduced lobes 57 of FIG. 7 being similarly transitioned to geometrical form 62. These geometrical forms 60, 62 are well adapted for production as simplified puzzle pieces.

In addition to planar, visual presentation, the forms 60, 62 may also be made three-dimensional, with the asymmetry-rendering form 62 being provided with attachment means such as a contact adhesive (preferred), Velcro™, magnet means or a pin, enabling its selective attachment and detachment with the form 60.

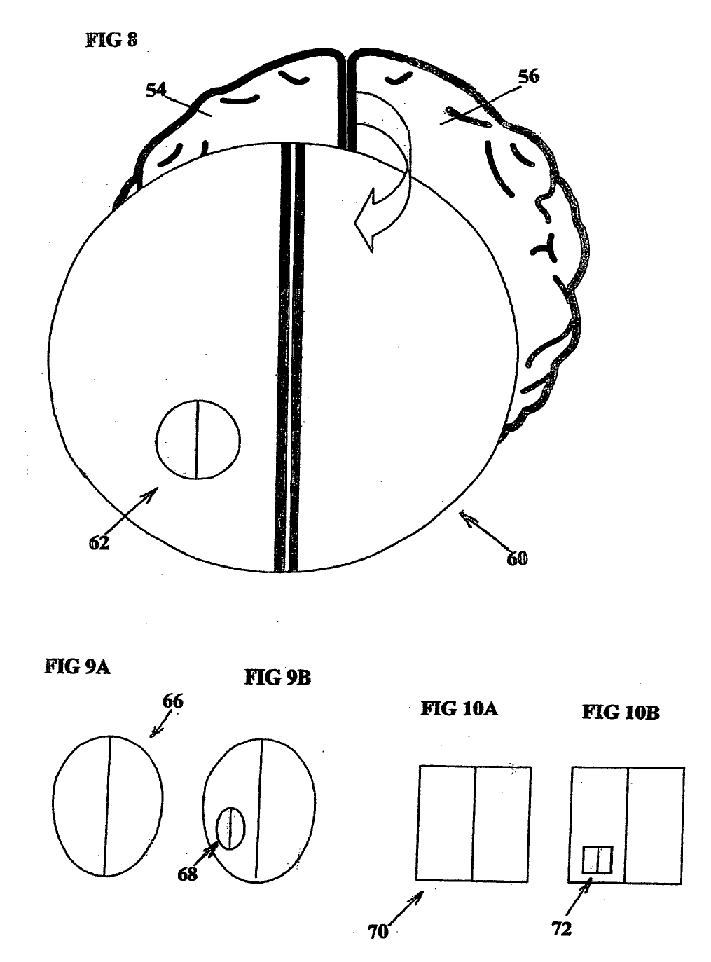

FIG. 9A shows a reduced size ovoid form of puzzle piece 66; and in FIG. 9B, an asymmetry-rendering form 68 is shown in attached relation with the piece 66.

FIG. 10A shows a reduced rectangular form of puzzle piece 70, and in FIG. 10B an asymmetry-rendering form 72 is shown in attached relation with the piece 70.

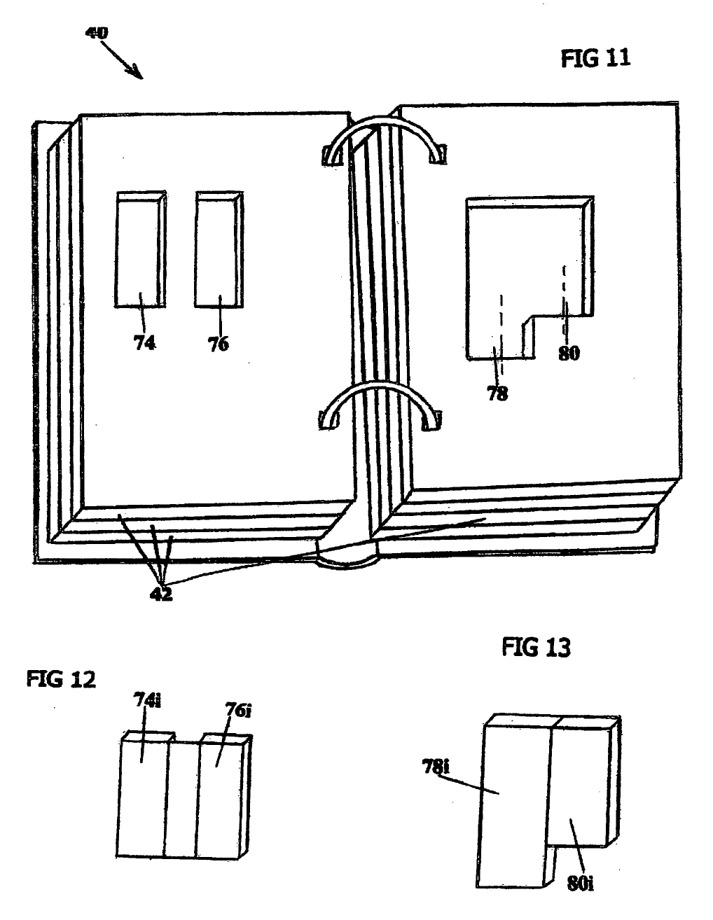

FIG. 11 is similar to FIG. 3, having pages 42 with cut-outs 74, 76, 78 and 80 that are precisely sized to receive the corresponding inserts 74i, 76i, 78i, and 80i that are shown in FIGS. 12 and 13. The inserts 74i and 76i are shown as being linked by a flexible live hinge.

It will be understood that wide varieties and variations, both of the product and of its method of use, lying within the scope of the attached claims, may be provided by those skilled in die art.

1. A visual comparison system, comprising: a first figure and a comparative second figure, wherein said first and second figures each contains at least one feature having the appearance of being substantially identical to that of the other figure, whereby, in use an observer may learn to identify the nature of a relationship between said first and said second figure.

2. The system as set forth in claim 1, wherein said first and said second figures are substantially identical.

3. The system as set forth in claim 2, wherein said second figure is a mirror image of said first figure.

4. The system as set forth in claim 1, wherein said first and said second figures are three-dimensional and tactile.

5. The system as set forth in claim 4, wherein said figures are substantially planar, having hinge means in interconnecting relation between selected ones of said figures, to enable a user to lay one said figure in substantial overlying coincidence over the interconnected other said figure, for visual and tactile assurance of substantially complete mutual symmetry.

6. The system as set forth in claim 1, wherein said first and said second figures are clearly different.

7. The system as set forth in claim 6, wherein said first and said second figures are three-dimensional and tactile.

8. The system as set forth in claim 7 wherein said figures are substantially planar, having hinge means in interconnecting relation between selected figures, to enable a user to lay one said figure over the other said figure, for visual and tactile assurance of mutual asymmetry.

9. The system as set forth in claim 1, including a book having shapes corresponding with at least one of said figures; said book having textual subject matter associated with the perceivable nature of said relationship between said first and said second figures.

10. The system as set form in claim 9, wherein said book shapes consist of figures in outline.

11. The system as set forth in claim 9, wherein said book shapes consist of page cut-outs sized to substantially precisely receive at least one said figure in inserted relation therein.

12. The system as set forth in claim 9, said book having shapes corresponding with said first and said second figures arranged in side-by-side relation; said book having textual subject matter associated with the perceivable mutually comparable relationship between said first and said second figures.

13. The system as set forth in claim 12, wherein said book shapes consist of page cut-outs sized to substantially precisely receive said figures in inserted relation therein.

14. The method of teaching perception enhancement, comprising the steps of providing a first article and a second article, said articles being selected from the group consisting of identical articles and dissimilar articles; and facilitating the comparison of said first article with said second article, to distinguish identical articles from dissimilar articles.

15. The method as set forth in claim 14, wherein individual ones of said articles are allocated to individual pupils, and a process of comparing articles and of pairing-up of pupils having comparable articles is followed.
